(19) United States
(12) Patent Application Publication
(10) Pub. No.: US 2003/0061608 A1
(43) Pub. Date: Mar. 27, 2003

(54) Content delivery system

(76) Inventor: Toyomi Yamagata, Matsubara City (JP)

Correspondence Address: David T. Nikaido, RADER, FISHMAN & GRAUER, PLLC, Suite 501, 1233 20th Street, NW, Washington, DC, 20036, US

(21) Appl. No.: 10/252,560

(22) Filed: Sep. 24, 2002

(30) Foreign Application Priority Data
Sep. 27, 2001 (JP) 2001-297775

(51) Int. Cl. H04N 7/10

(52) U.S. Cl. 725/34; 725/36

(57) ABSTRACT

A control server comprises means for presenting to a user terminal a menu screen for causing a user to select a content desired by the user as well as causing the user to select CM broadcast time intervals at the time of broadcasting the content on the basis of an access from the user terminal, and means for controlling a content server such that the content selected by the user is delivered to the user terminal in a time period excluding a time period during which a commercial message should be broadcast as well as controlling a CM server such that the commercial message is delivered to the user terminal in the time period during which the commercial message should be broadcast on the basis of the content and the CM broadcasting time intervals which are selected by the user on the menu screen.

### BACKGROUND OF THE INVENTION

1. Field of the Invention

The present invention relates to a content delivery system for delivering a content such as a movie through a network.

2. Description of the Prior Art

In a content delivery service utilizing the Internet, a subscriber system is a narrow band. Accordingly, a promotional service is mainly performed, and a viewer is hardly charged for the provision of a content. When a content such as a movie is delivered, such a service that a CM (Commercial Message) is delivered during the delivery of the content has not been performed yet.

### SUMMARY OF THE INVENTION

An object of the present invention is to provide a content delivery system capable of causing, when a user is caused to select a desired content, the user to also select CM broadcast time intervals.

Another object of the present invention is to provide a content delivery system capable of causing, when a user is caused to select a desired content, the user to also select CM broadcast time intervals and capable of presenting a content viewing charge previously set depending on the CM broadcast time intervals to the user at the time of selecting the CM broadcast time intervals.

A content delivery system according to the present invention is characterized by comprising a content server connected to a network and for delivering a content; a CM server connected to the network and for delivering a CM; a user terminal connected to the network and for receiving the content delivered from the content server and the CM delivered from the CM server to reproduce and output the received content and CM; and a control server connected to the network and for establishing communication with the user terminal as well as controlling the content server and the CM server, the control server comprising means for presenting to the user terminal a menu screen for causing a user to select a content desired by the user as well as causing the user to select CM broadcast time intervals at the time of broadcasting the content on the basis of an access from the user terminal, and means for controlling the content server such that the content selected by the user is delivered to the user terminal in a time period excluding a time period during which the CM should be broadcast as well as controlling the CM server such that the CM is delivered to the user terminal in the time period during which the CM should be broadcast on the basis of the content and the CM broadcasting time intervals which are selected by the user on the menu screen.

Examples of the menu screen are a first menu screen for causing the user to select the content desired by the user and a second menu screen provided after the content desired by the user is selected on the first menu screen and for causing the user to select the CM broadcast time intervals, a plurality of CM broadcast time interval selecting items indicating a plurality of CM broadcast time intervals and a content viewing charge set with respect to said selected content for each of the CM broadcast time interval selecting items being displayed on the second menu screen. The shorter the CM broadcast time intervals are, the lower the set content viewing charge is.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the configuration of a content delivery system; and

FIG. 2 is a schematic view showing an example of a main menu screen and a sub-menu screen.

### DESCRIPTION OF THE PREFERRED EMBODIMENTS

An embodiment of the present invention will be described.

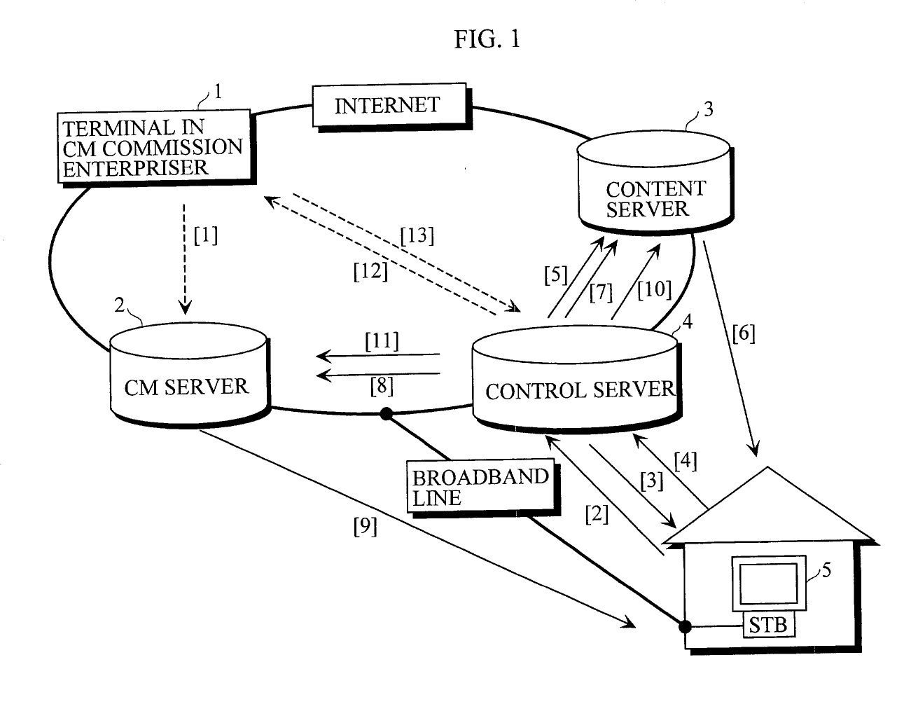

FIG. 1 illustrates the configuration of a content delivery system.

A terminal 1 in a CM commission enterpriser, a CM server 2, a content server 3, and a control server 4 are connected to the Internet. A user terminal 5 sets up in a home is connected to the Internet through a broadband line. The user terminal 5 comprises a browser function and the function of reproducing and outputting a CM and a content which are received.

The CM commission enterpriser produces a CM. The CM server 2 delivers the CM to the user terminal 5 in accordance with an instruction from the control server 4. The content server 3 delivers a content, a movie in this example, to the user terminal 5 in accordance with the instruction from the control server 4. The control server 4 interacts with a user through the user terminal 5 and controls the CM server 2 and the content server 3.

In FIGS. 1, [1] to [13] show the flow of the delivery of a content.

The CM commission enterpriser transmits the newest CM to the CM server 2 through the terminal 1 in the CM commission enterpriser and the Internet (step [1]). The CM server 2 receives the newest CM transmitted from the PC terminal 1 in the CM commission enterpriser and holds the received CM.

The user accesses the control server 4 through the user terminal 5, the broadband line, and the Internet when he or she desires to view a movie, to issue a request to present a menu (a menu presentation request) (step [2]).

The control server 4 presents, when it receives the menu presentation request from the user terminal 5, a menu screen to the user terminal 5 (step [3]).

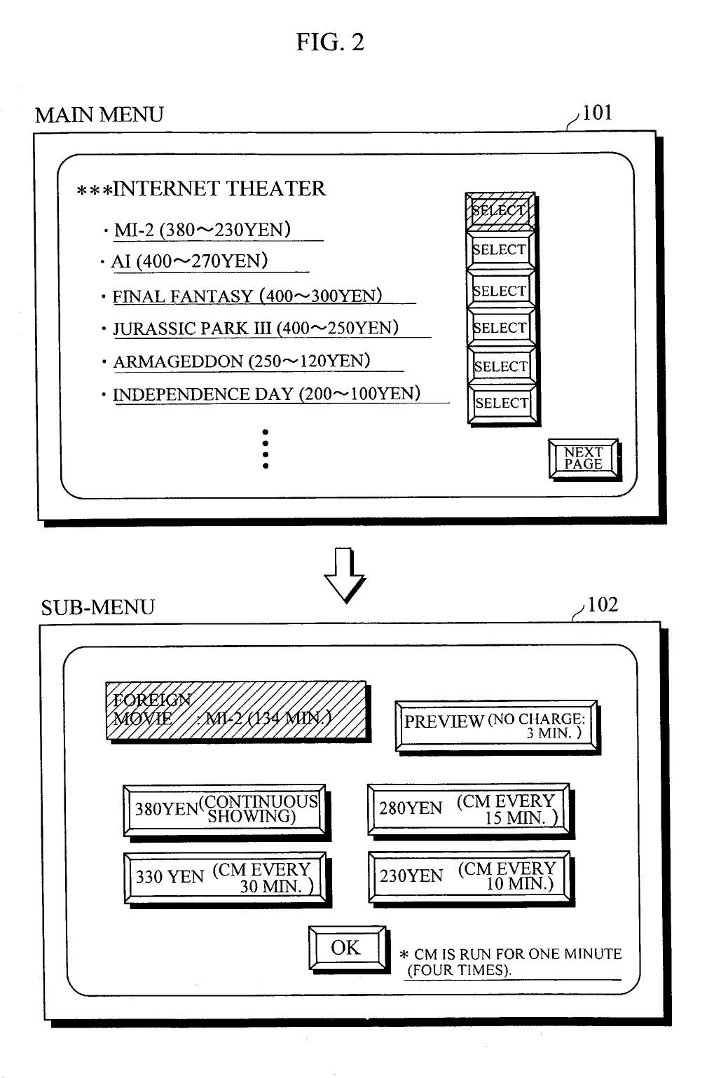

FIG. 2 shows an example of the menu screen. The control server 4 first presents, when it receives the menu presentation request from the user terminal 5, a main menu screen 101 illustrated on the upper side of FIG. 2 to the user terminal 5. The titles and the viewing charges of movies which can be provided by the content server 3, together with selection buttons, are displayed as a list on the main menu screen 101.

The user selects the movie which is desired to be viewed on the main menu screen 101. When the user selects the movie which is desired to be viewed on the main menu screen 101, information representing the selected movie is sent to the control server 4, and a sub-menu screen 102 illustrated on the lower side of FIG. 2 is presented to the user terminal 5 by the control server 4. The title of the movie selected by the user is displayed on the sub-menu screen 102, and a preview selection button, a plurality of CM broadcast time interval selection buttons, and an OK button are displayed thereon.

The preview selection button is a button for choosing whether or not a preview is viewed, and the viewing charge for the movie and CM broadcast time intervals are displayed on each of the buttons. The CM broadcast time interval selection button is a button for selecting CM broadcast time intervals. The shorter the CM broadcast time intervals are, the lower the viewing charge for the movie is.

In this example, the viewing charge for the movie is 380 yen in a continuous showing where no CM is broadcast, is 330 yen if CM broadcast time intervals are 30 minutes, is 280 yen if CM broadcast time intervals are 15 minutes, and is 230 yen if CM broadcast time intervals are 10 minutes.

The user clicks the preview selection button when he or she views the preview. Further, the user clicks one, corresponding to the desired CM broadcast time intervals, of the plurality of CM broadcast time interval selection buttons. The user then presses the OK button.

When the user presses the OK button, information indicating whether or not the preview is viewed and information related to the CM broadcast time intervals selected by the user are sent to the control server 4.

The control server 4 transmits, when the information representing the movie selected by the user, the information indicating whether or not the preview is viewed, and the information related to the CM broadcast time intervals selected by the user are obtained by communication with the user terminal 5 (step [4]), an instruction to deliver the movie selected by the user to the user terminal 5 (a content sending instruction) (step [5]).

The content server 3 delivers, when it receives the content sending instruction, the corresponding movie to the user terminal 5 (step [6]). Consequently, the broadcasting of the movie is started at the user terminal 5.

The control server 4 transmits an instruction to temporarily stop the sending of the movie (a content temporary sending stop instruction) to the content server 3 at the time when a CM is broadcast (step [7])), and transmits an instruction to send out the CM (a CM sending instruction) to the CM server 2 (step [8]) on the basis of the CM broadcast time intervals selected by the user.

The content server 3 stops, when it receives the content temporary sending stop instruction, the delivery of the movie. The CM server 2 delivers, when it receives the CM sending instruction, the CM to the user terminal 5 (step [9]).

The control server 4 transmits an instruction to resume the sending of the movie (a content sending resumption instruction) to the content server 3 (step [10]), and transmits an instruction to stop sending out the CM (a CM sending stop instruction) to the CM server 2 (step [11]) when a predetermined time period during which the CM is broadcast once (one minute in this example) has elapsed.

The content server 3 resumes, when it receives the content sending resumption instruction, the delivery of the movie. The CM server 2 stops, when it receives the CM sending stop instruction, the transmission of the CM.

Thereafter, the same processing is repeated, thereby delivering the movie selected by the user and delivering the CM. When the delivery of the movie is terminated, the control server 4 notifies the terminal 1 in the CM commission enterpriser of a time period during which the CM is broadcast (step [12]). The CM commission enterpriser pays a charge corresponding to the time period, during which the CM is broadcast, received from the control server 4 to a manager of the control server 4 (step [13]).

Although the present invention has been described and illustrated in detail, it is clearly understood that the same is by way of illustration and example only and is not to be taken by way of limitation, the spirit and scope of the present invention being limited only by the terms of the appended claims.

What is claimed:

1. A content delivery system comprising:
a content server connected to a network and for delivering a content;
a CM server connected to the network and for delivering a commercial message;
a user terminal connected to the network and for receiving the content delivered from the content server and the commercial message delivered from the CM server to reproduce and output the received content and commercial message; and
a control server connected to the network and for establishing communication with the user terminal as well as controlling the content server and the CM server,
the control server comprising
means for presenting to the user terminal a menu screen for causing a user to select a content desired by the user as well as causing the user to select CM broadcast time intervals at the time of broadcasting the content on the basis of an access from the user terminal; and
means for controlling the content server such that the content selected by the user is delivered to the user terminal in a time period excluding a time period during which the commercial message should be broadcast as well as controlling the CM server such that the commercial message is delivered to the user terminal in the time period during which the commercial message should be broadcast on the basis of the content and the CM broadcasting time intervals which are selected by the user on the menu screen.

2. The content delivery system according to claim 1, wherein
examples of the menu screen are a first menu screen for causing the user to select the content desired by the user and a second menu screen provided after the content desired by the user is selected on the first menu screen and for causing the user to select the CM broadcast time intervals,
a plurality of CM broadcast time interval selecting items indicating a plurality of CM broadcast time intervals and a content viewing charge set with respect to said selected content for each of the CM broadcast time interval selecting items being displayed on the second menu screen.

3. The content delivery system according to claim 2, wherein
the shorter the CM broadcast time intervals are, the lower the set content viewing charge is.
